(19) United States
(12) Patent Application Publication
(10) Pub. No.: US 2009/0249791 A1
(43) Pub. Date: Oct. 8, 2009

(54) TRANSITION PIECE IMPINGEMENT SLEEVE AND METHOD OF ASSEMBLY

(75) Inventor: Keith Cletus Belsom, Laurens, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/099,469

(22) Filed: Apr. 8, 2008

(51) Int. Cl. F01D 25/24; B23P 17/00; F23R 3/42; F23R 3/60

(52) U.S. Cl. 60/755; 60/752; 29/434; 29/525.11; 29/525.06

(57) ABSTRACT

Disclosed herein is an impingement sleeve for a gas turbine combustion transition piece. The impingement sleeve includes, a housing positionable proximate a first portion of a transition piece body having at least two flanges integrally formed thereon, and a cover positionable proximate a second portion of the transition piece body having at least two lips integrally formed thereon, the at least two lips are weldlessly attachable to the at least two flanges to position the impingement sleeve radially outwardly of the transition piece body.

### BACKGROUND OF THE INVENTION

The subject matter disclosed herein relates to an impingement sleeve for a gas turbine engine. Such impingement sleeves are typically fixedly attached about a transition piece. The geometry of some transition pieces necessitates that the impingement sleeve be made of two or more portions that are assembled around the transition piece and fixedly attached to one another. In such applications, it is common practice to weld the two or more portions of the impingement sleeves together. Such welding operations can be difficult to perform and can make replacing defective impingement sleeves in the field time consuming and difficult. As such, impingement sleeves that are easily assembled and disassembled may be well received in the art.

### BRIEF DESCRIPTION OF THE INVENTION

Disclosed herein is an impingement sleeve for a gas turbine combustion transition piece. The impingement sleeve includes, a housing positionable proximate a first portion of a transition piece body having at least two flanges integrally formed thereon, and a cover positionable proximate a second portion of the transition piece body having at least two lips integrally formed thereon, the at least two lips are weldlessly attachable to the at least two flanges to position the impingement sleeve radially outwardly of the transition piece body.

Further disclosed herein is a method of assembling an impingement sleeve at a transition piece body. The method includes, positioning a housing of the impingement sleeve over a first portion of the transition piece body, positioning a cover of the impingement sleeve over a second portion of the transition piece body, and weldlessly attaching at least one flange of the impingement sleeve housing to at least one lip of the impingement sleeve cover.

### BRIEF DESCRIPTION OF THE DRAWINGS

The following descriptions should not be considered limiting in any way. With reference to the accompanying drawings, like elements are numbered alike:

FIG. 1 depicts a perspective view of an impingement sleeve disclosed herein assembled to a gas turbine combustion transition piece;

FIG. 2 depicts an exploded view of the impingement sleeve and the transition piece of FIG. 1;

FIG. 3 depicts a cross sectional perspective view of the impingement sleeve and the transition piece of FIG. 1; and

FIG. 4 depicts a cross sectional view of the impingement sleeve and the transition piece of FIG. 1.

### DETAILED DESCRIPTION OF THE INVENTION

A detailed description of one or more embodiments of the disclosed apparatus and method are presented herein by way of exemplification and not limitation with reference to the Figures.

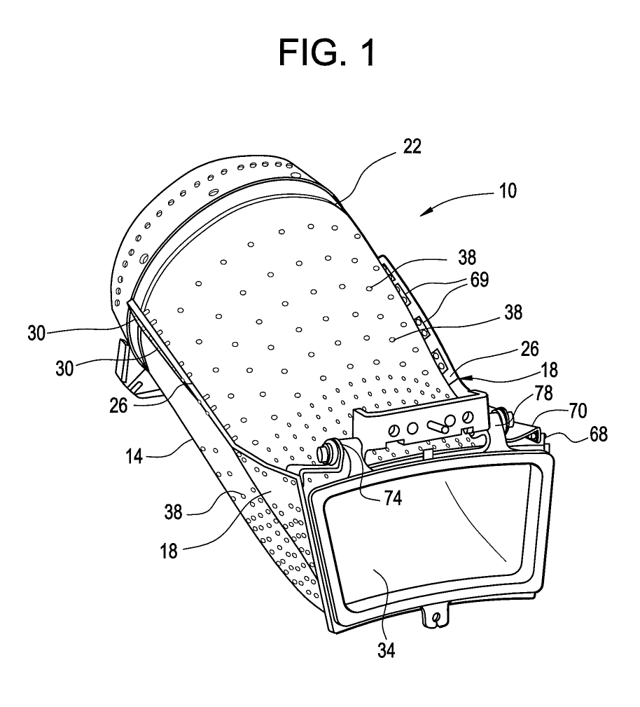

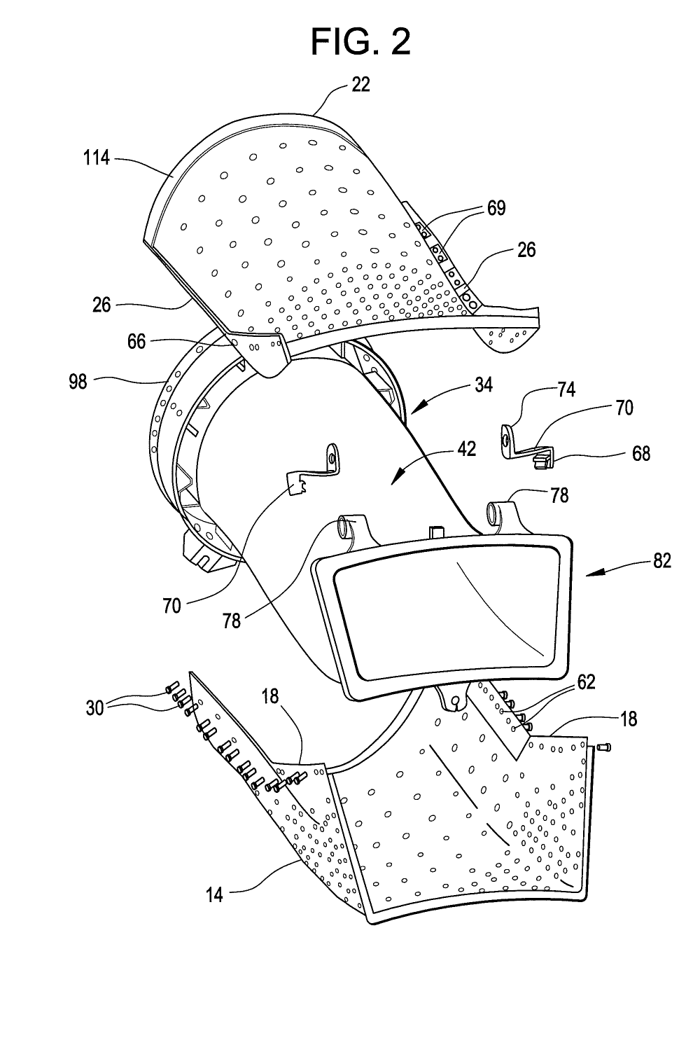

Referring to FIGS. 1 and 2, an embodiment of an impingement sleeve 10 disclosed herein is illustrated. The impingement sleeve 10 includes, an impingement sleeve housing 14 having mounting flanges 18, an impingement sleeve cover 22 having mounting lips 26, and a plurality of fasteners 30, depicted herein as screws. In the assembled configuration, as illustrated in FIG. 1, the impingement sleeve 10 is positioned radially outwardly of a gas turbine combustion transition piece 34, which has an outer surface 42. Both the housing 14 and the cover 22 have a plurality of holes 38 therethrough that allow cooling fluid, such as air, to pass therethrough.

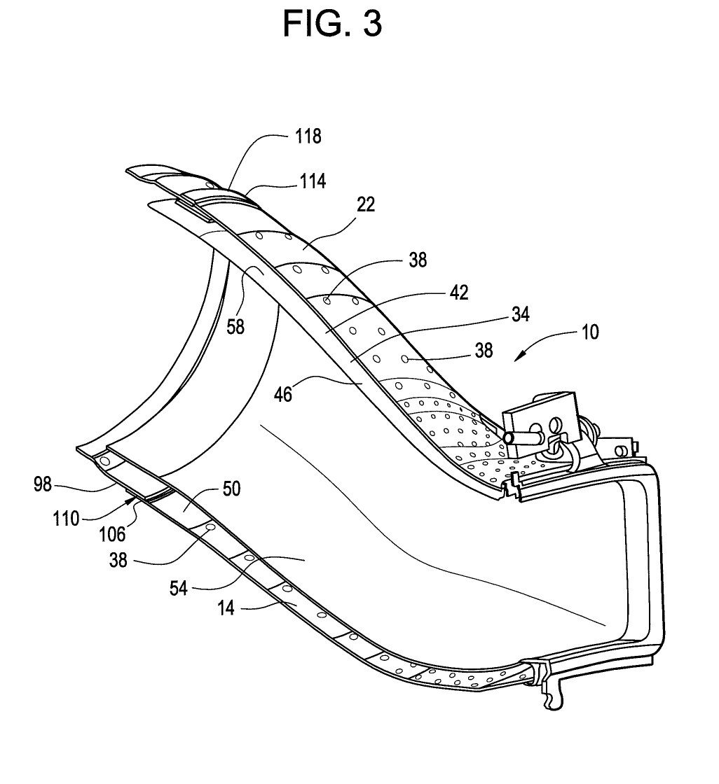

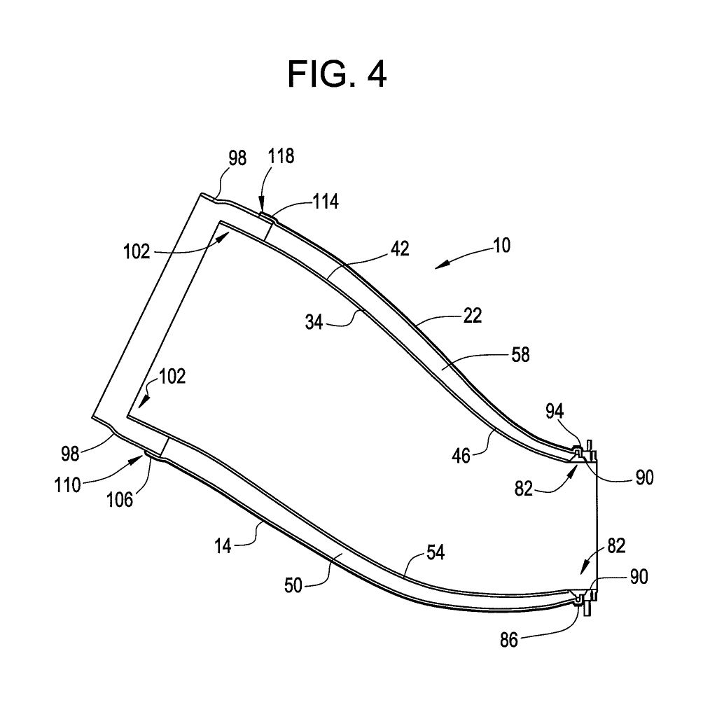

Referring to FIGS. 3 and 4, the housing 14 is formed to closely mimic a shape of a portion 46 of the transition piece 34 to which the housing 14 is positioned in close proximity. As such, a controlled gap 50 is created between the housing 14 and the portion 46. Similarly, the cover 22 is formed to closely mimic a shape of a portion 54 of the transition piece 34 to which the cover 22 is positioned in close proximity. As such, a controlled gap 58 is created between the cover 22 and the portion 54. During operation cooling fluid flows through the holes 38 in the housing 14 and cover 22, across the gaps 50 and 58, and impinges on the outer surface 42 of the portions 46 and 54, respectively, thereby cooling the transition piece 34.

The housing 14 and the cover 22 are configured such that the flanges 18 and the lips 26 are substantially parallel with one another when the housing 14 and the cover 22 are positioned in an encasing configuration about the transition piece 34. When in this position, a plurality of holes 62 in the flanges 18 aligns with a plurality of holes 66 in the lips 26, through which a plurality of fasteners 30 is fastened. The fasteners 30, in this embodiment, are screws that screw into threaded holes in plates 69; however, alternate embodiments could use rivets, pins or other fasteners to attach the flanges 18 to the lips 26. In still other embodiments the flanges 18 could be attached to the lips 26 by other techniques that do not involve welding, such as by crimping of one of the flanges 18 and the lips 26 to the other of the flanges 18 and the lips 26, or by attaching the flanges 18 to the lips 26 with an adhesive, for example.

A first end 68 of each of a pair of support brackets 70 are attached by a pair of the fasteners 30 to one of the flanges 18 and one of the lips 26 on either side of the housing 14 or cover 22. A second end 74 of each of the support brackets 70 is attached to one of a pair of protrusions 78 from a first end 82 of the transition piece 34. The brackets 70 positionally support the housing 14 and the cover 22 relative to the first end 82 of the transition piece 34. Additional support between the housing 14 and the first end 82 of the transition piece 34 is provided by an edge 86 of the housing 14 that extends into a slot 90 in the first end 82. Similarly, additional support between the cover 22 and the first end 82 of the transition piece 34 is provided by an edge 94 of the cover 22 that extends into the slot 90 in the first end 82. In addition to supporting the housing 14 and the cover 22, engagement of the edges 86, 94 with the slot 90 provides a fluidic seal that blocks cooling fluid from flowing into the gaps 50, 58 through this interface.

The housing 14 and the cover 22 are supported and sealed to a conduit 98 located near a second end 102 of the transition piece 34. An edge 106 of the housing 14 forms a lap joint 110 with the conduit 98, and an edge 114 of the cover 22 forms a lap joint 118 with the conduit 98. Hoop strength generated by assembly of the housing 14 with the cover 22 maintains the edges 106 and 114 in contact with the conduit 98 to assure support thereto and sealing therebetween.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used, in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. An impingement sleeve for a gas turbine combustion transition piece, comprising:
a housing positionable proximate a first portion of a transition piece body having at least two flanges formed thereon; and
a cover positionable proximate a second portion of the transition piece body having at least two lips formed thereon, the at least two lips being weldlessly attachable to the at least two flanges to position the impingement sleeve radially outwardly of the transition piece body.

2. The impingement sleeve of claim 1, wherein the at least two flanges and the at least two lips have a plurality of holes receptive of fasteners.

3. The impingement sleeve of claim 2, wherein the fasteners are screws.

4. The impingement sleeve of claim 3, wherein a plurality of the screws threadably engage with a plurality of threaded holes in a plate.

5. The impingement sleeve of claim 2, wherein the fasteners are rivets.

6. The impingement sleeve of claim 1, wherein at least one of the at least two flanges and the at least two lips are attachable to one or more brackets.

7. The impingement sleeve of claim 1, wherein at least one of the housing and the cover have a plurality of holes therethrough for passage of cooling fluid.

8. The impingement sleeve of claim 1, wherein the housing is configured to maintain a gap between the housing and the transition piece.

9. The impingement sleeve of claim 1, wherein the cover is configured to maintain a gap between the cover and the transition piece.

10. The impingement sleeve of claim 1, wherein the housing further includes a first edge and the cover further includes a second edge such that the first edge and the second edge form a collar that is engagable with an end portion of the transition piece.

11. The impingement sleeve of claim 10, wherein the engagement of the collar and the end portion create a seal.

12. The impingement sleeve of claim 1, wherein the housing further includes a first rim and the cover further includes a second rim and the first rim and the second rim are sealably engagable with a conduit at a second end of the transition piece.

13. A method of assembling an impingement sleeve at a transition piece body, comprising:
positioning a housing of the impingement sleeve over a first portion of the transition piece body;
positioning a cover of the impingement sleeve over a second portion of the transition piece body; and
weldlessly attaching at least one flange of the impingement sleeve housing to at least one lip of the impingement sleeve cover.

14. The method of claim 13, wherein the weldlessly attaching further includes fastening with screws.

15. The method of claim 13, wherein the weldlessly attaching further includes fastening with rivets.

16. The method of claim 13, further comprising:
engaging the housing to a first end of the transition piece; and
engaging the cover to the first end of the transition piece.

17. The method of claim 16, further comprising:
sealing the housing to the first end; and
sealing the cover to the first end.

18. The method of claim 13, further comprising:
engaging the housing to a conduit on a second end of the transition piece; and
engaging the cover to the conduit on the second end of the transition piece.

19. The method of claim 18, further comprising:
sealing the housing to the conduit; and
sealing the cover to the conduit.

20. The method of claim 13, further comprising:
maintaining a gap between the housing and the transition piece; and
maintaining a gap between the cover and the transition piece.
